(19) United States
(12) Patent Application Publication
(10) Pub. No.: US 2010/0169796 A1
(43) Pub. Date: Jul. 1, 2010

(54) Visual Indication of Audio Context in a Computer-Generated Virtual Environment

(75) Inventors: John Chris Lynk, Kanata (CA); Arn Hyndman, Ottawa (CA)

Correspondence Address: Anderson Gorecki & Manaras, LLP;Attn: John C. Gorecki, P.O BOX 553, CARLISLE, MA, 01741, US

(73) Assignee: Nortel Networks Limited, St. Laurent (CA)

(21) Appl. No.: 12/344,569

(22) Filed: Dec. 28, 2008

(51) Int. Cl. G06F 3/14

(52) U.S. Cl. 715/757

(57) ABSTRACT

A method and apparatus for providing a visual indication of audio context in a computer-generated virtual environment is provided. In one embodiment, visual indicators of which other Avatars are within communication distance of an Avatar may be generated and provided to the user associated with the Avatar. The visual indication may be provided for Avatars within the viewing area regardless of whether the other Avatar is visible or not. The visual indication may be provided for Avatars outside of the viewing area as well. When Avatars are engaged in a communication session, an indication of which Avatars are involved as well as which Avatar is currently speaking may be provided. Context may be user specific and established for each user of the virtual environment based on the location of that user's Avatar within the virtual environment and the relative location of other users' Avatars within the virtual environment.

### CROSS-REFERENCE TO RELATED APPLICATIONS

None

### BACKGROUND OF THE INVENTION

1. Field of the Invention

The present invention relates to virtual environments and, more particularly, to a method and apparatus for providing a visual indication of audio context in a computer-generated virtual environment.

2. Description of the Related Art

Virtual environments simulate actual or fantasy two-dimensional and three-dimensional environments and allow for many participants to interact with each other and with constructs in the environment via remotely-located clients. One context in which a virtual environment may be used is in connection with gaming, although other uses for virtual environments are also being developed.

In a virtual environment, an actual or fantasy universe is simulated within a computer processor/memory. Multiple people may participate in the virtual environment through a computer network, such as a local area network or a wide area network such as the Internet. Each player selects an “Avatar” which is often a three-dimensional representation of a person or other object to represent them in the virtual environment. Participants send commands to a virtual environment server that controls the virtual environment to cause their Avatars to move within the virtual environment. In this way, the participants are able to cause their Avatars to interact with other Avatars and other objects in the virtual environment.

A virtual environment often takes the form of a virtual-reality two or three dimensional map, and may include rooms, outdoor areas, and other representations of environments commonly experienced in the physical world. The virtual environment may also include multiple objects, people, animals, robots, Avatars, robot Avatars, spatial elements, and objects/environments that allow Avatars to participate in activities. Participants establish a presence in the virtual environment via a virtual environment client on their computer, through which they can create an Avatar and then cause the Avatar to “live” within the virtual environment.

As the Avatar moves within the virtual environment, the view experienced by the Avatar changes according to where the Avatar is located within the virtual environment. The views may be displayed to the participant so that the participant controlling the Avatar may see what the Avatar is seeing. Additionally, many virtual environments enable the participant to toggle to a different point of view, such as from a vantage point outside of the Avatar, to see where the Avatar is in the virtual environment.

The participant may control the Avatar using conventional input devices, such as a computer mouse and keyboard. The inputs are sent to the virtual environment client, which enables the user to control the Avatar within the virtual environment.

Depending on how the virtual environment is set up, an Avatar may be able to observe the environment and optionally also interact with other Avatars, modeled objects within the virtual environment, robotic objects within the virtual environment, or the environment itself (i.e. an Avatar may be allowed to go for a swim in a lake or river in the virtual environment). In these cases, client control input may be permitted to cause changes in the modeled objects, such as moving other objects, opening doors, and so forth, which optionally may then be experienced by other Avatars within the virtual environment.

Virtual environments are commonly used in on-line gaming, such as for example in online role playing games where users assume the role of a character and take control over most of that character's actions. In addition to games, virtual environments are also being used to simulate real life environments to provide an interface for users that will enable on-line education, training, shopping, and other types of interactions between groups of users and between businesses and users.

As Avatars encounter other Avatars within the virtual environment, the participants represented by the Avatars may elect to communicate with each other. For example, the participants may communicate with each other by typing messages to each other or an audio bridge may be established to enable the participants to talk with each other.

Unlike conventional audio conference calls, which are generally used to interconnect a limited number of people, an audio communication session in a virtual environment may interconnect a very large number of people. For example, the number of participants who can join a session can scale to be tens, hundreds, or even thousands of users. The number of participants that a user can hear and speak with can also vary rapidly, i.e. more than one per second, as the user moves within the virtual environment. Finally, unlike a traditional voice bridge, a virtual environment communication session may enable multiple conversations to go on at once, with users in one conversation hearing just a little bit of another conversation, similar to being at a party.

These features of virtual environments lead to several challenges. First, users can be overheard in unexpected ways. A new user may teleport in or out of a site close to the user. Similarly, other users may walk up behind the user without the user's knowledge. Users may also be able to hear through walls, ceilings, floors, doors, etc., so the fact that a user can't see another Avatar does not mean that the other user can't hear them. These problems are exasperated by the fact that users don't have peripheral vision or the ability to sense very subtle sounds like footsteps or feel displaced air as someone moves within the virtual environment. Additionally, users don't have a good sense for how far their voice will travel within the virtual environment and thus may not even know which of the visible Avatars are able to hear them, much less which of the non-visible Avatars are able to hear them.

Where there are multiple people connected through the virtual environment, it is often difficult to identify who was speaking when there are several possible speakers. Since off screen Avatars are not identified, if an off-screen Avatar talks, all that a user is provided with is a disembodied voice.

Unfortunately, traditional solutions used for IP voice bridges (e.g. list of users on the bridge) does not function well with the scale and dynamics common to virtual worlds. Only a limited number of users can be shown at any given time in a list, and thus as the list becomes too long the other names will simply scroll off the screen. Additionally, once the list exceeds a particular length it is difficult to determine, at a glance, if a new user has joined the communication session. Also, a list provides no sense of how close the user is and, therefore, how likely they are to be active participants in the conversation.

### SUMMARY OF THE INVENTION

A method and apparatus for providing a visual indication of audio context in a computer-generated virtual environment is provided. In one embodiment, visual indicators of which other Avatars are within communication distance of an Avatar may be generated and provided to the user associated with the Avatar. The visual indication may be provided for Avatars within the field of view regardless of whether the other Avatar is visible or not visible because hidden by another object within the field of view. The visual indication may be provided for Avatars outside of the field of view as well. Indications may also be provided to show which Avatars are currently speaking, when users outside the field of view enter/leave the communication session, when someone invokes a special audio feature such as the ability to have their voice heard throughout a region of the virtual environment, etc. Context may be user specific and established for each user of the virtual environment based on the location of that user's Avatar within the virtual environment and the relative location of other users' Avatars within the virtual environment.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a portion of an example system enabling users to have access to a computer-generated virtual environment;

FIGS. 2 and 3 show an example computer-generated virtual environment through which a visual indication of audio context may be provided to a user according to an embodiment of the invention; and

FIG. 4 is a functional block diagram showing components of the system of FIG. 1 interacting to enable visual indication of audio context to be provided to users of a computer-generated virtual environment according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

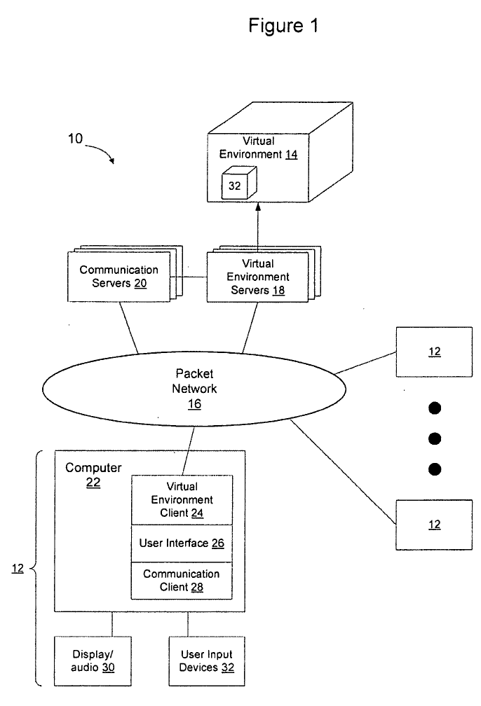

FIG. 1 shows a portion of an example system 10 showing the interaction between a plurality of users 12 and one or more virtual environments 14. A user may access the virtual environment 14 from their computer 22 over a packet network 16 or other common communication infrastructure. The virtual environment 14 is implemented by one or more virtual environment servers 18. Audio may be exchanged within the virtual environment between the users 12 via one or more communication servers 20. In one embodiment, the audio may be implemented by causing the communication server 20 to mix audio for each user based on the user's location in the virtual environment. By mixing audio for each user, the user may be provided with audio from users that are associated with Avatars that are proximate the user's Avatar within the virtual environment. This allows the user to talk to people who have Avatars close to the user's Avatar while allowing the user to not be overwhelmed by audio from users who are farther away. One way to implement Audio in a virtual environment is described in U.S. patent application Ser. No. 12/344,542, filed Dec. 28, 2008, entitled Realistic Communications in a Three Dimensional Computer-Generated Virtual Environment, the content of which is hereby incorporated herein by reference.

The virtual environment may be implemented as using one or more instances, each of which may be hosted by one or more virtual environment servers. Where there are multiple instances, the Avatars in one instance are generally unaware of Avatars in the other instance. Conventionally, each instance of the virtual environment may be referred to as a separate World. In the following description, it will be assumed that the Avatars are instantiated in the same world and hence can see each other and communicate with each other. A world may be implemented by one virtual environment server 18, or may be implemented by multiple virtual environment servers.

The virtual environment 14 may be any type of virtual environment, such as a virtual environment created for an on-line game, a virtual environment created to implement an on-line store, a virtual environment created to implement an on-line training facility, business collaboration, or for any other purpose. Virtual environments are being created for many reasons, and may be designed to enable user interaction to achieve a particular purpose. Example uses of virtual environments include gaming, business, retail, training, social networking, and many other aspects.

Generally, a virtual environment will have its own distinct three dimensional coordinate space. Avatars representing users may move within the three dimensional coordinate space and interact with objects and other Avatars within the three dimensional coordinate space. The virtual environment servers maintain the virtual environment and pass data to the virtual environment client to enable the virtual environment client to render the virtual environment for the user. The view shown to the user may depend on the location of the Avatar in the virtual environment, the direction in which the Avatar is facing, the zoom level, and the selected viewing option, such as whether the user has opted to have the view appear as if the user was looking through the eyes of the Avatar, or whether the user has opted to pan back from the Avatar to see a three dimensional view of where the Avatar is located and what the Avatar is doing in the three dimensional computer-generated virtual environment.

Each user 12 has a computer 22 that may be used to access the three-dimensional computer-generated virtual environment. The computer 22 will run a virtual environment client 24 and a user interface 26 to the virtual environment. The user interface 26 may be part of the virtual environment client 24 or implemented as a separate process. A separate virtual environment client may be required for each virtual environment that the user would like to access, although a particular virtual environment client may be designed to interface with multiple virtual environment servers. A communication client 28 is provided to enable the user to communicate with other users who are also participating in the three dimensional computer-generated virtual environment. The communication client may be part of the virtual environment client 24, the user interface 26, or may be a separate process running on the computer 22.

The user may see a representation of a portion of the three dimensional computer-generated virtual environment on a display/audio 30 and input commands via a user input device 32 such as a mouse, touch pad, or keyboard. The display/audio 30 may be used by the user to transmit/receive audio information while engaged in the virtual environment. For example, the display/audio 30 may be a display screen having a speaker and a microphone. The user interface generates the output shown on the display under the control of the virtual environment client, and receives the input from the user and passes the user input to the virtual environment client. The virtual environment client passes the user input to the virtual environment server which causes the user's Avatar 34 or other object under the control of the user to execute the desired action in the virtual environment. In this way the user may control a portion of the virtual environment, such as the person's Avatar or other objects in contact with the Avatar, to change the virtual environment for the other users of the virtual environment.

Typically, an Avatar is a three dimensional rendering of a person or other creature that represents the user in the virtual environment. The user selects the way that their Avatar looks when creating a profile for the virtual environment and then can control the movement of the Avatar in the virtual environment such as by causing the Avatar to walk, run, wave, talk, or make other similar movements. Thus, the block 34 representing the Avatar in the virtual environment 14, is not intended to show how an Avatar would be expected to appear in a virtual environment. Rather, the actual appearance of the Avatar is immaterial since the actual appearance of each user's Avatar may be expected to be somewhat different and customized according to the preferences of that user. Since the actual appearance of the Avatars in the three dimensional computer-generated virtual environment is not important to the concepts discussed herein, Avatars have generally been represented herein using simple geometric shapes or two dimensional drawings, rather than complex three dimensional shapes such as people and animals.

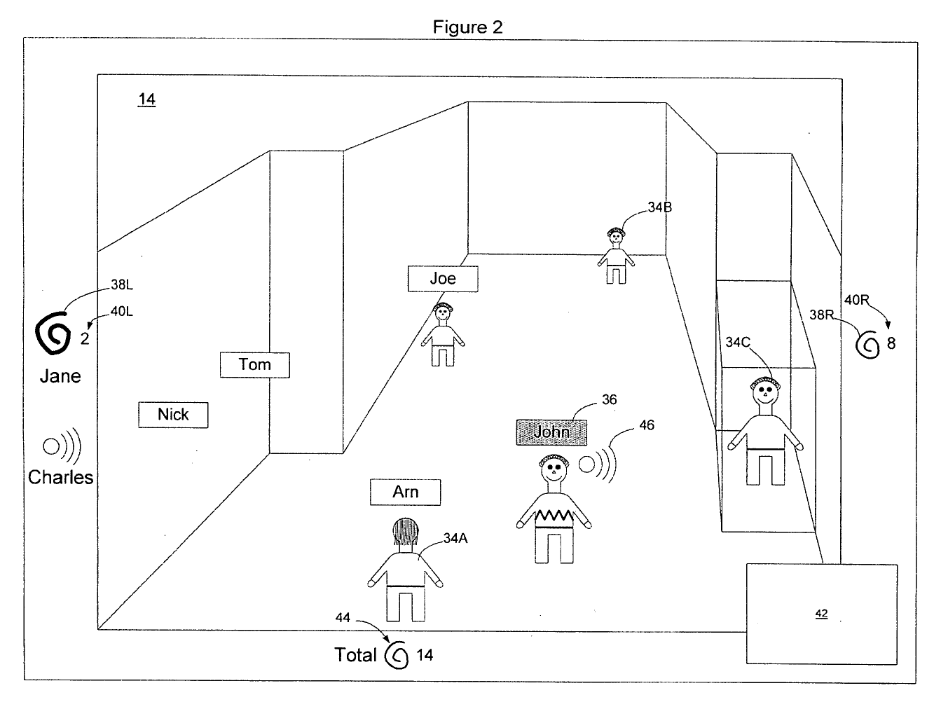

FIG. 2 shows a portion of an example three dimensional computer-generated virtual environment and shows some of the features of the visual presentation that may be provided to a user of the virtual environment to provide additional audio context according to an embodiment of the invention. As shown in FIG. 2, Avatars 34 may be present and move around in the virtual environment. It will be assumed for purposes of discussion that the user of the virtual environment in this Figure is represented by Avatar 34A. Avatar 34A may be labeled with a name block 36 as shown or, alternatively, the name block may be omitted as it may be assumed that the user knows which Avatar is representing the user. In FIG. 2, Avatar 34A is facing away from the user and looking into the three dimensional virtual environment.

In the embodiment shown in FIG. 2, the user associated with Avatar 34A can communicate with multiple other users of the virtual environment. Whenever the users are sufficiently close to the user, audio generated by those other users is automatically included in the audio mix provided to the user, and conversely audio generated by the user is able to be heard by the other users. To enable the user to know which Avatars are part of the communication session, the Avatars that are within range are marked so that the user can visually determine which Avatars the user can talk to and, hence, which users can hear what the user is saying. In one embodiment the Avatars that are within hearing distance may be provided with a name label 36. The presence of the name label indicates that the other user can hear what the user is saying. In the example shown in FIG. 2, Avatar 34A can talk to and can hear John and Joe. The user can also see Avatar 34B but cannot talk to him since he is too far away. Hence, no name label has been drawn above Avatar 34B.

In one embodiment of the invention, the size of the name label on each of the Avatars that is within talking distance may be rendered to be the same size so that the user can read the name tag regardless of the distance of the Avatar within the virtual environment. This enables the user associated with Avatar 34A to be able to clearly see who is within communicating distance. In this embodiment, the name blocks do not get smaller if the Avatar is farther away. Rather, the same sized name block is used for all Avatars that are within communicating distance, regardless of distance from the user's Avatar.

There are other Avatars that are also within hearing distance of the Avatar 34A, but which cannot be seen by the user because of the other obstacles in the three dimensional computer generated virtual environment. In one embodiment, if audio is not blocked by a wall or other object, then Avatar markers show through the object so that the user can determine that there is an Avatar behind the object that can hear them. For example, on the left side of the virtual environment, two names labels (Nick and Tom) are shown on the wall. These name labels are associated with Avatars that are on the opposite side of the wall which, in this illustrated example, does not attenuate sound. Hence, since the users on the other side of the wall can hear the user, the name labels have been rendered on the wall to provide the user with information about those users. As those Avatars move around behind the wall, the name labels will move as well.

Some virtual environments model audio propagation with greater and lesser accuracy. For example, in some virtual worlds the walls block sound but the floors/ceilings do not. Other virtual environments may model sound differently. Even if sound is modeled accurately such that both walls and ceilings attenuate sound, providing the name labels of users who are behind obstacles and can still hear is advantageous since it allows the user to know which person is listening. Thus, for example, if the virtual environment models sound accurately a person could still be listening through a crack in the door or could be hiding behind a bush. By including a visual indication of the location of anyone that can hear, the person would not be able to engage in this type of eavesdropping in the virtual environment.

Avatar 34C is visible in FIG. 2 and is close enough to Avatar 34A that the two users associated with those Avatars should be able to communicate. However, Avatar 34C in the example shown in FIG. 2 is behind an audio barrier such as a glass wall which prevents the Avatars from hearing each other, but enables the Avatars to still see each other. Although there may be a physical indication that the users are behind an audio barrier, the actual private room is realized by a fact that the users that are within the private room are on a private audio connection rather than the general audio connection. If the users within the private room are also able to hear the user, they will be provided with name labels to indicate that they are able to hear the user. However, in this example it has been assumed that the Avatars in the private room cannot hear the user because of the barrier. Hence, Avatar 34C is visible to Avatar 34A but cannot communicate with Avatar 34A. Thus, a name label has not been drawn for Avatar 34C. Similarly, Avatar 34B is visible to Avatar 34A but is outside of the communication distance from Avatar 34A. Thus, the users associated with Avatars 34A and 34B are too far apart to communicate with each other. Accordingly, a name label has not been drawn for the Avatar 34B. The lack of a name label signifies that the Avatar is too far away and that the user cannot talk to that Avatar. Similarly, the lack of a name label signifies that the user associated with the non-labeled Avatar cannot listen in on conversations being held by Avatar 34A.

In FIG. 2 there are also additional features that are provided to help the user associated with Avatar 34A understand whether there are other not-visible Avatars that are within communication distance. Specifically, in the example shown in FIG. 2, a hearability icon 38L is shown on the left hand margin of the user's display and a hearability icon 38R is shown on the right hand side of the display. The presence of a hearability icon indicates that there are other Avatars off screen that are within communicating distance of the user's Avatar that are located in that direction. The other Avatars are located in a part of the virtual environment that is not part of the user's field of view. Hence, the Avatars cannot be seen by the Avatar. Depending on the configuration of the virtual environment, the Avatar may be able to turn in the direction of the hearability icon to see the names of the Avatars that are in that direction and which are within hearing distance of the user.

In the example shown in FIG. 2, a numerical designator 40L, 40R is provided next to the hearability icon. The numerical designator tells the user how many other Avatars are in hearing distance but off screen in that direction. In the example shown in FIG. 2 the numerical designator 40L is “2” which indicates that there are two Avatars located toward the Avatar's left in the virtual environment that can hear him. The two Avatars are not the Avatars Tom and Nick, since those Avatar's name blocks are visible and, hence, are not reflected by the numerical designator. In another embodiment, the numerical designator may include the invisible Avatars that have visible name blocks.

The hearability icon is positioned around the user's screen on the appropriate side to indicate to the user where the other Avatars are located that can hear the Avatar. Where Avatars are located in multiple locations, multiple hearability icons may be provided. For example, in the example shown in FIG. 2, a hearability icon 38 is provided on both the left and right hand sides of the screen. On the left hand side the associated numerical designator 40L indicates that there are two people that can hear the Avatar 34A in that direction, and on the right hand side the associated numerical designator 40R indicates that there are 8 people that can hear the Avatar 34A. Where there are Avatars above and below the user, additional hearabilith icons may be positioned on the top edge and bottom edge of the screen as well.

As Avatars move in and out of communication range, the numerical designators will be updated. Additionally, the hearability icon may be modified to indicate when a new Avatar comes within communication range. For example, the hearability icon may be increased in size, color, or intensity, it may flash, or it may otherwise alert the user that there is a new Avatar in that direction that is within communication distance. For example, hearability indicator 38L has been increased in size since Jane has just joined on that side. Jane's name has also been drawn below the hearability indicator so the user knows who just joined the communication session. Use of a hearability icon provides a very compact representation to alert the user that there are other people that can hear the user's conversation. The user can turn in the direction of the hearability icon to see who the users are. Since any user that can hear will be rendered with a name label, the user can quickly determine who is listening.

The user associated with Avatar 34A may also be provided with a summary of the total number of people that are within communication distance if desired. The summary in the illustrated example includes a legend such as “Total”, a representation of the hearability icon, and a summary numerical designator which shows how many people are within communicating distance. In the illustrated example, there are 8 Avatars to the right of the screen, 2 Avatars to the left, 2 Avatars (Nick and Tom) that are not visible but which have visible name blocks, and 2 visible Avatars which have name blocks. Accordingly, the summary 44 indicates that 14 total people are within communicating distance of the Avatar 34A.

In the embodiment shown in FIG. 2, there are other visual clues that enable the user to understand who is participating in an audio session, and who is speaking on the audio session. Different icons or symbols may be used to show who is listening vs who is speaking. For example, a volume indicator 46 may be used to show the volume of any particular user who contributed audio, i.e. speaks, and to enable the user to mentally tie the cadence of the various speakers to their Avatars via the synchronized motion of the volume indicators. The volume indicator in one embodiment has a number of bars that may be successively lit/drawn as the user speaks to indicate the volume of the user's speech so that the cadence may more closely be matched to the particular user.

In the example shown in FIG. 2, a volume indicator 46 is shown adjacent the Avatar that is associated with a person that is currently talking. When John talks, the volume indicator 46 will be generated adjacent John's Avatar and shown to both Am and Nick via their virtual environment clients. When John stops talking, the talking indicator will fade out or be deleted so that it no longer appears. As other people talk, similar volume indicators will be drawn adjacent their Avatars in each of the users' displays, so that each user knows who is talking and so that each of the users can understand which other user said what. This allows the users to have a more realistic audio experience and enables them to better keep track of the flow of a conversation between participants in a virtual environment.

In one embodiment, the volume indicator may persist for a moment after the user has stopped speaking to allow people to determine who just spoke. The volume indicator may be provided, for example, with a 0 volume to indicate that the person has just stopped speaking. After a period of silence, the volume indicator will be removed. This allows people to determine who just spoke even after the person stops talking.

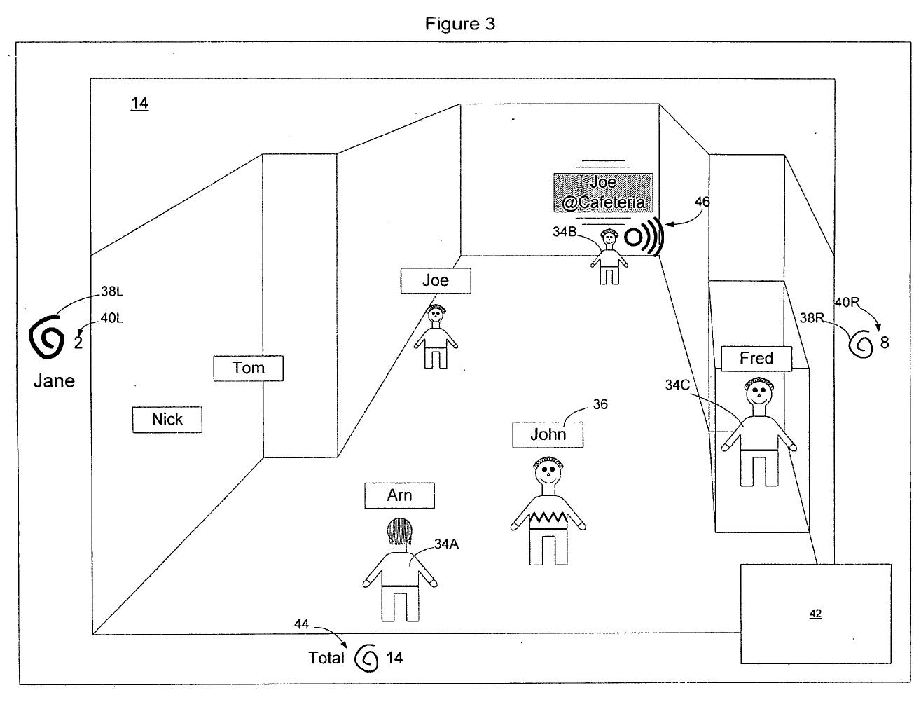

Other icons and indications may be used to provide additional information about the type of audio that is present in the virtual environment. For example, as shown in FIG. 3, depending on the implementation, it may be possible for one or more of the users of the virtual environment to use a control to make their voice audible throughout a region of the virtual environment. This feature will be referred to as OmniVoice. When a speaker has invoked OmniVoice, a label indicating the location of the speaker is provided to enable the location of the speaker to be discerned. The location may optionally be included as part of the user's name label. For example, in FIG. 3 Joe is invoking OmniVoice from the cafeteria. The location of the speaker may also be provided as an icon on a 2-D map. Other ways of indicating the location of the speaker may be used as well.

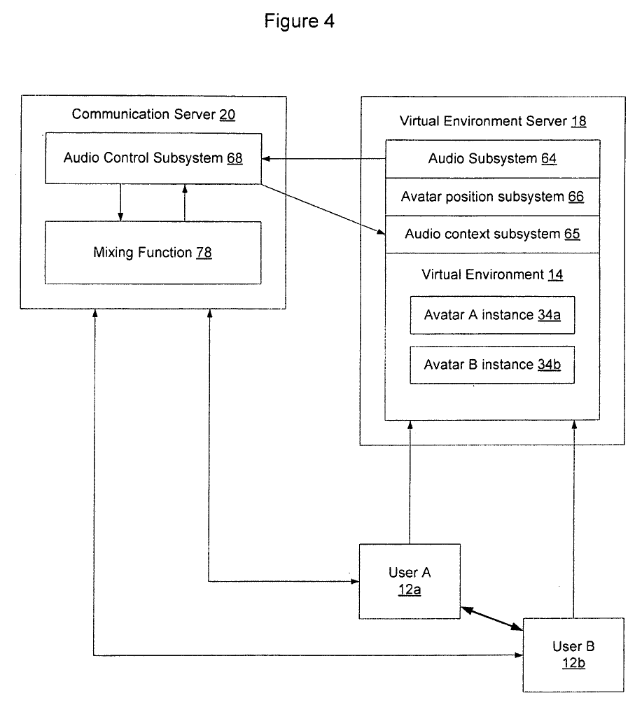

FIG. 4 shows a system that may be used to provide a visual indication of audio context within a computer-generated virtual environment according to an embodiment of the invention. As shown in FIG. 4, users 12 are provided with access to a virtual environment 14 that is implemented using one or more virtual environment servers 18.

Users 12A, 12B are represented by avatars 34A, 34B within the virtual environment 14. When the users are sufficiently proximate each other, as determined by the avatar position subsystem 66, audio will be transmitted between the users associated with the Avatars. Information will be passed to an audio context subsystem 65 of the virtual environment server to enable the visual indication of audio context to be provided to the users.

Users 12A, 12B are represented by avatars 34A, 34B within the virtual environment 14. When the users are proximate each other, an audio subsystem 64 will determine that audio should be transmitted between the users associated with the Avatars. The audio subsystem 64 will pass this information to an audio control subsystem 68 which controls a mixing function 78. The mixing function 78 will mix audio for each user of the virtual environment to provide individually determined audio streams to each of the Avatars. Where the communication server is part of the virtual environment server, the input may be passed directly from the audio subsystem 64 to the mixing function 78. As users approach the user the audio for those users will be added to the mixed audio. Similarly, as users move away from the user they will no longer contribute audio on the mixed audio.

As users communicate with each other, the communication server will monitor which user is talking and pass this information back to the audio context subsystem 65 of the virtual environment server. The audio context subsystem 65 will use the feedback from the communications server to generate the visual indication of audio context related to which participant in an audio communication session is currently talking on the session.

Although particular modules have been described in connection with FIG. 4 as performing various tasks associated with providing visual indication of audio context, the invention is not limited to this particular embodiment as many different ways of allocation functionality between components of a computer system may be implemented. Thus, the particular implementation will depend on the particular programming techniques and software architecture selected for its implementation and the invention is not intended to be limited to the one illustrated architecture.

The functions described above may be implemented as one or more sets of program instructions that are stored in a computer readable memory and executed on one or more processors within on one or more computers. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of selectively enabling audio context to be provided to a user of a computer-generated virtual environment, the method comprising the steps of:
determining which Avatars are within listening distance of the user's Avatar in the virtual environment;
marking Avatars that are within listening distance of the user's Avatar different from Avatars that are not within listening distance of the user's Avatar.

2. The method of claim 1, wherein Avatars that are within listening distance of the user's Avatar are marked regardless of whether they are visible within a field of view of the user's Avatar.

3. The method of claim 2, wherein a name plate is provided for each Avatar that is not visible but contained within the field of view.

4. The method of claim 3, wherein if an Avatar is obscured by an obstacle within the field of view, the name plate is shown on the obstacle to show the user where the Avatar is located behind the obstacle.

5. The method of claim 1, wherein Avatars that are within the field of view of the user's Avatar and are within listening distance of the user's Avatar are marked with a name plate, and Avatars that are within the field of view of the user's Avatar and not within listening distance of the user's Avatar are not marked with a name plate.

6. The method of claim 3, wherein all name plates are the same size regardless of how far away the associated Avatar is from the user's Avatar in the virtual environment.

7. The method of claim 1, wherein at least one hearability icon is provided on an edge of the virtual environment to indicate a presence of Avatars that are outside the field of view and present in the virtual environment.

8. The method of claim 7, wherein the hearability icon is displayed on the edge of the virtual environment in the direction of the Avatar that is outside the field of view of the user's Avatar.

9. The method of claim 7, wherein the hearability icon is highlighted whenever a new Avatars comes within listening distance.

10. The method of claim 9, wherein a name of the user associated with the new Avatar is also provided whenever the new Avatar comes within listening distance.

11. The method of claim 7, wherein a total is provided to indicate a total number of other users that can hear the user.

12. The method of claim 1, further comprising marking Avatars whenever a user associated with the Avatar speaks to indicate who is talking within the virtual environment.

13. The method of claim 1, wherein the step of marking Avatars is implemented for Avatars that are within the field of view and for Avatars that are not within the field of view.

14. The method of claim 13, wherein the step of marking Avatars that are speaking and not within the field of view comprises showing the name of the person who is speaking on the side of the screen where the Avatar is located within the virtual environment.

15. The method of claim 1, further comprising the step of highlighting any person invoking an ability to broadcast their voice to a region of the virtual environment.

16. The method of claim 15, wherein the step of highlighting includes providing a name associated with the user invoking the ability and a location indication of the Avatar within the virtual environment.

17. A method of selectively enabling audio context to be provided to a user of a computer-generated virtual environment, the method comprising the steps of:
determining which other Avatars are visible to the first Avatar within the virtual environment;
determining which of the other visible Avatars are within communicating distance of the first Avatar;
for those Avatars that are visible and within communicating distance of the first Avatar, providing a visual indication associated with each such Avatar to indicate which of the other Avatars are within communicating distance of the first Avatar;
determining which other Avatars are not visible to the first Avatar and are within communicating distance of the first Avatar;
providing a visual indication to the user to alert the user to the presence of the other Avatars that are not visible to the first Avatar and are within communicating distance of the first Avatar.

18. The method of claim 17, wherein any users having an Avatar within communicating distance of the first Avatar are automatically included on a communication session with a user associated with the first Avatar.
